(19) United States
(12) Patent Application Publication
(10) Pub. No.: US 2021/0387895 A1
(43) Pub. Date: Dec. 16, 2021

(54) SCRIM GLASS MANAGEMENT

(71) Applicant: CORNING INCORPORATED, CORNING, NY (US)

(72) Inventors: Adam Brian Gibson, Horseheads, NY (US); EuiHo Kim, Asan-si (KR); ChaHyun Ku, Gumi-si (KR); Sue Camille Lewis, Webster, NY (US); Dale Charles Marshall, Brockport, NY (US)

(21) Appl. No.: 17/287,372

(22) PCT Filed: Oct. 9, 2019
(86) PCT No.: PCT/US2019/055359

§ 371 Date: Apr. 21, 2021

Related U.S. Application Data
(60) Provisional application No. 62/750,444, filed on Oct. 25, 2018.

(51) Int. Cl. C03B 37/12; C03B 37/16

(52) U.S. Cl. CPC C03B 37/12; C03B 37/16

(57) ABSTRACT

Example systems described herein are configured to manage a continuous scrim-glass web slit from a side of a continuous glass web. For instance, a system may include a first roller, a nipping roller, and a breaker. The first roller is configured to support the continuous scrim-glass web. The nipping roller is configured to isolate vibration originating from the continuous scrim-glass web by applying pressure onto the continuous scrim-glass web that is threaded between the nipping roller and the first roller. The breaker is configured to intermittently break portions of the continuous scrim-glass web from the continuous scrim-glass web while the continuous scrim-glass web traverses between the nipping roller and the first roller by applying a force to the continuous scrim-glass web.

This application claims the benefit of priority under 35 U.S.C. § 119 of U.S. Provisional Application No. 62/750,444, filed Oct. 25, 2018, the content of which is incorporated herein by reference in its entirety.

### BACKGROUND

The proliferation of mobile devices (e.g., phones, tablets, and laptops) in modern society has substantially increased demand for high performance glass. In a conservative estimate, approximately 9 billion smartphones will be in circulation by the year 2020 due in large part to such smartphones being the primary means by which people access the Internet. Mobile devices typically contain electronic components printed on high-quality ultra-thin glass, which often has high surface quality, high transmission, and no flaws or imperfections. Such ultra-thin glass can be produced in a glass roll production process. In conventional glass roll production processes, the side edges of the continuous glass web are cut (e.g., using a rotary cutting blade), and the cut web portions on the left and right sides of the continuous glass web are collected onto waste rolls—one on each side of the continuous glass web. Waste rolls can accumulate quickly and can telescope if not properly aligned. When the waste rolls are full or misaligned, the production process is stopped, which can adversely affect the production throughput. Accordingly, a technique is needed to manage waste glass that is accumulated during processing.

### SUMMARY

Various systems described herein are configured to manage a continuous scrim-glass web slit from a side of a continuous glass web. A continuous glass web is a continuous sheet of glass that is passed over rollers (e.g., contact rollers, conveyance rollers, air bars, etc.). For instance, the continuous glass web may be passed over the rollers directly or via a conveyor belt that rotates around the rollers. A continuous scrim-glass web is a portion of a continuous glass web (e.g., left edge or right edge portion of the continuous glass web) that has been slit from a side edge of the continuous glass web (e.g., for collection followed by disposal or recycle).

A first example system includes a first roller, a nipping roller, and a breaker. The first roller is configured to support the continuous scrim-glass web. The nipping roller is configured to isolate vibration originating from the continuous scrim-glass web by applying pressure onto the continuous scrim-glass web that is threaded between the nipping roller and the first roller. The breaker is configured to intermittently break portions of the continuous scrim-glass web from the continuous scrim-glass web while the continuous scrim-glass web traverses between the nipping roller and the first roller by applying a force to the continuous scrim-glass web.

A second example system includes a slitting station, a first scrim management station, and a second scrim management station. The slitting station is configured to slit a continuous glass web into first, second, and third continuous webs. The first and second continuous webs are continuous scrim-glass webs slit from respective left and right sides of the continuous glass web. The first scrim management station comprises a first nipping roller and a first breaker. The first nipping roller is configured to isolate vibration originating from the first continuous scrim-glass web by applying pressure onto the first continuous scrim-glass web that is between the first nipping roller and a first support roller. The first breaker is configured to intermittently break portions of the first continuous scrim-glass web from the first continuous scrim-glass web while the first continuous scrim-glass web traverses between the first nipping roller and the first support roller by applying a force to the first continuous scrim-glass web. The second scrim management station comprises a second nipping roller and a second breaker. The second nipping roller is configured to isolate vibration originating from the second continuous scrim-glass web by applying pressure onto the second continuous scrim-glass web that is between the second nipping roller and a second support roller. The second breaker is configured to intermittently break portions of the second continuous scrim-glass web from the second continuous scrim-glass web while the second continuous scrim-glass web traverses between the second nipping roller and the second support roller by applying a force to the second continuous scrim-glass web.

In an example method of intermittently breaking portions of a continuous scrim-glass web from the continuous scrim-glass web, the continuous scrim-glass web is fed onto a first conveyance roller. Pressure is applied on opposing faces of the continuous scrim-glass web to isolate vibration from the continuous scrim-glass web by pressing the continuous scrim-glass web between a nipping roller and the first conveyance roller. Portions are intermittently broken from the continuous scrim-glass web as the continuous scrim-glass web passes between the nipping roller and the first conveyance roller by applying a breaking force, using a breaker, to the portions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example glass roll preparation system in accordance with some embodiments of the present disclosure.

FIG. 2 is a perspective view of a scrim-glass management station shown in FIG. 1 in accordance with some embodiments of the present disclosure.

FIGS. 3, 4A, 4B, 5A, 5B, and 5C are side views of a scrim-glass management station shown in FIG. 1 in accordance with some embodiments of the present disclosure.

FIG. 6 is a side view of a scrim-glass management station shown in FIG. 1 in accordance with some embodiments of the present disclosure.

FIG. 7 is a side view of a scrim-glass management station shown in FIG. 1 in accordance with some embodiments of the present disclosure.

FIG. 8 depicts a flowchart of an example method for breaking portions from a continuous scrim-glass web in accordance with some embodiments of the present disclosure.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” “some embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

### I. EXAMPLE EMBODIMENTS

Example systems described herein are configured to manage a continuous scrim-glass web slit from a side of a continuous glass web. A continuous glass web is a continuous sheet of glass that is passed over rollers (e.g., contact rollers, conveyance rollers, air bars, etc.). For instance, the continuous glass web may be passed over the rollers directly or via a conveyor belt that rotates around the rollers. A continuous scrim-glass web is a portion of a continuous glass web (e.g., left edge or right edge portion of the continuous glass web) that has been slit from a side edge of the continuous glass web (e.g., for collection followed by disposal or recycle).

The example systems described herein have a variety of benefits as compared to conventional scrim management systems. For instance, the example systems may automatically manage a continuous scrim-glass web without having to collect the continuous scrim-glass web onto a waste roll. It will be recognized that collecting a continuous scrim-glass web onto a waste roll may be problematic for a variety of reasons. For example, waste rolls in conventional systems can build up quickly and can require the production line to be intermittently stopped so that new waste rolls can be installed. This can greatly reduce the throughput and efficiency of the production line. In another example, the waste rolls can consume a substantial amount of space on the production floor. In yet another example, a continuous scrim-glass web collected on a waste roll can become misaligned. Misalignment of the continuous scrim-glass web can cause the waste roll to telescope. If not properly rectified, the telescoping waste roll can slip and collapse, which can negatively affect nearby operations and/or cause the production line to shutdown entirely.

The example systems may manage a continuous scrim-glass web by vibrationally isolating the continuous scrim-glass web from the main continuous glass web (i.e., the glass web from which the scrim-glass web is slit). This can be accomplished by applying pressure on the top and bottom surfaces of the continuous scrim-glass web using a nipping roller and a conveyance roller. For instance, the continuous scrim-glass web can be squeezed between the nipper and conveyance rollers, which are configured to apply a designated amount of force to the continuous scrim-glass web. In one aspect, pressure can be applied to the continuous scrim-glass web between a nipping roller and a conveyor belt, which is supported and driven by one or more conveyance rollers. Vibrational isolation of the continuous scrim-glass web can be further enhanced by using vibration-absorbing (e.g., vibration-dampening) material(s) on the surfaces of the nipping roller, the conveyance roller, and/or the conveyor belt. Examples of a vibration-absorbing material include but are not limited to rubber and soft urethane.

The example systems can use a breaker to intermittently break the continuous scrim-glass web into manageable portions as the continuous scrim-glass web continuously traverses over the conveyance roller (e.g., a conveyor belt that rotates about the conveyance roller). It will be recognized that the continuous scrim-glass web can continuously traverse over the conveyance roller at substantially the same speed as the main continuous glass web traveling in the production line. The manageable portions, which are created by the intermittent breaking of the continuous scrim-glass web, can then be dropped into a hopper where they can be stored. In this way, the example systems may eliminate a need to collect the continuous scrim-glass onto waste rolls, which often are more complicated to handle and require intermittent shutdown of the production line. For example, the example systems can intermittently break the continuous scrim-glass web using a breaker that intermittently applies a breaking force to the continuous scrim-glass web. The breaking force can be applied a spaced distance away from the nipping point (i.e., the point where the continuous scrim-glass web is pressed or squeezed between the nipping roller and the conveyance roller) to generate a torque on the continuous scrim-glass web, which causes a portion of the continuous scrim-glass web between the nipping point and the location where the breaking force is applied to break off. The breaking force can be applied rapidly and suddenly to a contact area (e.g., a designated portion of the surface area) of the continuous scrim-glass web. In one example, the contact area can be a relatively small defined area. In another example, the contact area can be a relatively large and narrow area that partially or entirely extends in the cross-web direction.

The breaker can be mounted on a pivotable breaker arm that is mounted to the same axis as the nipping roller such that the breaker and the pivotable breaker arm pivot about the nipping roller. The breaker can be actuated using a motor to rotate the pivotable breaker arm or using a linear hydraulic motor (e.g., hydraulic cylinder) to push the pivotable breaker arm toward the continuous scrim-glass web.

The example systems can include a scriber configured to score (a.k.a. scribe) the continuous scrim-glass web to make it readily breakable at or near the scored area. For instance, by scoring the continuous scrim-glass web, the scriber can create a mark on the continuous scrim-glass web. The mark may be a defect in the physical structure of the continuous scrim-glass web. The mark can have any suitable shape, including but not limited to a line or an arc. The scriber can be a diamond tipped edge or blade that is mounted on a rotatable arm or on a spring-loaded arm that can be traversed in the cross-web direction using a linear motor. For example, the scriber can be mounted on a rotatable arm or wheel that is configured to intermittently actuate to cause the scriber to swing and score the continuous scrim-glass web to create a physical defect on the surface of the continuous scrim-glass web. The rotatable arm can be configured to rotate at a high speed relative to the speed of the continuous scrim-glass such that the continuous scrim-glass web is scored along a substantially straight line in the cross-web direction.

The example systems can include a second nipping roller configured to apply pressure onto the continuous scrim-glass web before the continuous scrim-glass web is scored by the scriber. In this way, any potential vibration from the scoring process can be substantially reduced (e.g., eliminated). In this example, the continuous scrim-glass web may be scored when it is isolated between two nipping rollers. The breaking area (i.e., the area where the breaker makes physical contact with the continuous scrim-glass web to break off a manageable portion) is located after the nipping rollers in the processing line. In this manner, any potential vibration from the breaking process can be substantially reduced (e.g., eliminated) by the nipping rollers and/or the conveyance rollers.

Typically, in a glass roll production process, the main continuous glass web is slit on both left and right sides (i.e., edges) leaving two separate continuous scrim-glass webs. Accordingly, in a glass roll production process in which the main continuous glass web is slit on both sides, two example systems for managing a scrim-glass web may be implemented—one on each side of the main continuous web to manage the respective continuous scrim-glass web. Each of the example systems may be configured to isolate, intermittently score, and intermittently break the respective continuous scrim-glass web into manageable portions while the continuous scrim-glass web is moving at relatively the same speed as the main continuous glass web, which is moving through the production process.

One or more of the nipping rollers, the conveyance rollers, and/or the conveyor belt of the example systems can have a surface made of a vibration-absorbing material. Examples of a vibration-absorbing material include but are not limited to rubber and a soft urethane. The combination of the vibration-absorbing material and the pressure being applied to the continuous scrim-glass web by one or more of the nipping rollers, the conveyance rollers, and/or the conveyor belt can reduce vibration traveling upstream (i.e., against the direction of travel of the continuous scrim-glass web) by at least a threshold percentage. For instance, the threshold percentage may be 70%, 80%, 90%, or 95%. In this way, any vibration produced by the intermittently breaking of the continuous scrim-glass web can be dampened, which may reduce the overall vibration introduced to the production line.

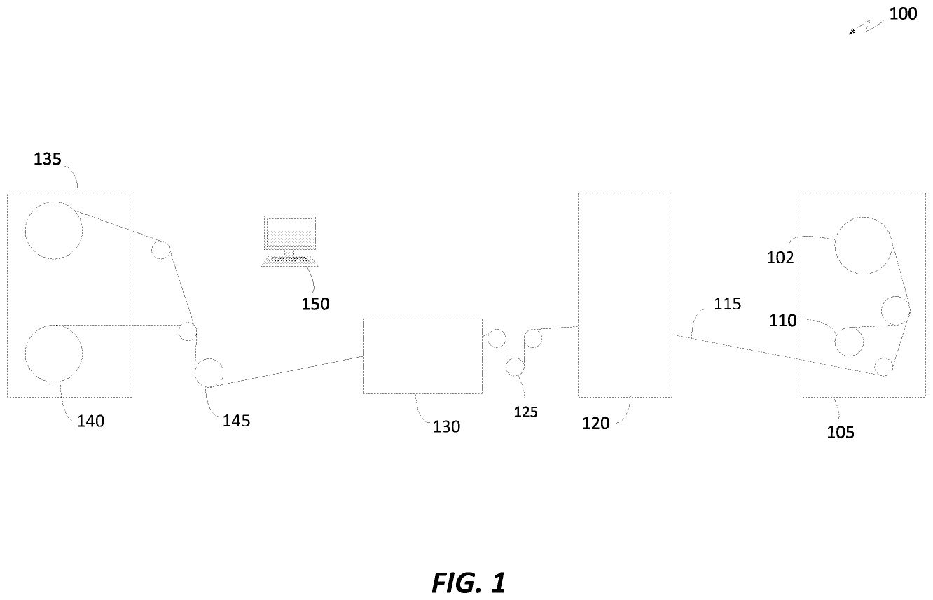

FIG. 1 is a block diagram of an example glass roll preparation system 100 (hereinafter “preparation system 100”) in accordance with some embodiments of the present disclosure. Generally, preparation system 100 operates to prepare a roll of material (e.g., glass) for shipping. For instance, preparation system 100 can prepare a glass roll 102 in accordance with a customer specification prior to shipping glass roll 102 to the customer. In accordance with this example, preparation system 100 can cut glass roll 102 to a specified width and/or a glass web 115 in glass roll 102 to a specified length to enable glass roll 102 to fit into the customer's manufacturing processes. Glass roll 102 can include a liner (e.g., as specified by the customer) between adjacent layers of glass web 115 in glass roll 102 to protect a surface of glass web 115 from being scratched. Preparation system 100 can receive glass roll 102, including the liner, from a glass roll fabrication line (not shown) at an unwinding station 105. Unwinding station 105 can include a liner collection roll 110 to collect the liner as glass roll 102 is unwound to expose glass web 115.

Preparation system 100 also includes a slitting station 120, a scrim-glass management station 130, a winding station 135, and a controller 150. Slitting station 120 is configured to slit one or more scrim-glass webs from glass web 115. For instance, slitting station can slit a right scrim-glass web from a right side of glass web 115 and a left scrim-glass web from a left side of glass web 115. After slitting is performed, glass web 115 may be referred to as the trimmed continuous glass web. By slitting the right and left sides of glass web 115, slitting station 120 may cause the trimmed continuous glass web to have a specified (e.g., pre-defined) width. Slitting station 120 can slit the sides of glass web 115 using a mechanical cutting apparatus (e.g., a diamond cutter) or a laser. Preparation system 100 can also include a dancer roller 125 to control the tension of glass web 115. Having a proper web tension may facilitate achieving a proper hardness and roll density of the final glass roll at winding station 135. Additionally, having too much tension may cause glass web 115 to break, and having too little tension may cause glass web 115 to roll up and become damaged.

It will be recognized that preparation system 100 can include multiple scrim-glass management stations 130, e.g., one for each side of glass web 115. For instance, preparation system 100 can include a scrim-glass management station 130 on each side of glass web 115. Each scrim-glass management station 130 is configured to receive and vibrationally isolate a continuous scrim-glass web moving at relatively the same speed as glass web 115. Scrim-glass management station 130 can include one or more nipping rollers and one or more conveyance rollers. Vibrational isolation can be accomplished by pulling the continuous scrim-glass web between a nipping roller and a conveyance roller to apply pressure to the top and bottom surfaces of the continuous scrim-glass web. The bottom surface of the continuous scrim-glass web can be supported by conveyance roller(s) (e.g., by a conveyor belt that rotates about the conveyance roller(s)). The conveyance roller(s) can be coupled to a controller 150 that controls the speed at which the conveyance roller(s) rotate based at least in part on the speed of glass web 115. In this way, a speed mismatch between the continuous scrim-glass web and glass web 115 can be avoided. For instance, such a speed mismatch can cause a variety of production issues, including breakage of glass web 115.

Winding station 135 can also include a liner roll 140 and a laminating station 145, which laminates a liner onto glass web 115. The liner can be the same as or different from the liner collected by liner collection roller 110. For instance, the liner that is laminated onto glass web 115 by the laminating station 145 may be a specialty liner as ordered by the customer.

Each station (e.g., winding station 105, slitting station 120, proof testing station 130, winding station 135) of preparation system 100 can be communicatively coupled to controller 150, which may enable each of the stations to communicate with any one or more of the other stations. Controller 150 can be configured to control one or more functions of each station. For example, controller 150 can be configured to control dancer roller 125 to actively control the tension of glass web 115. In another example, controller 150 can be configured to control one or more functions of proof testing station 130 such that proof testing can be performed on glass web 115. Controller 150 can include hardware, software, firmware, or any combination thereof. Controller 150 can also be integrated into one of the stations of preparation system 100 or can be distributed across any two or more of the stations.

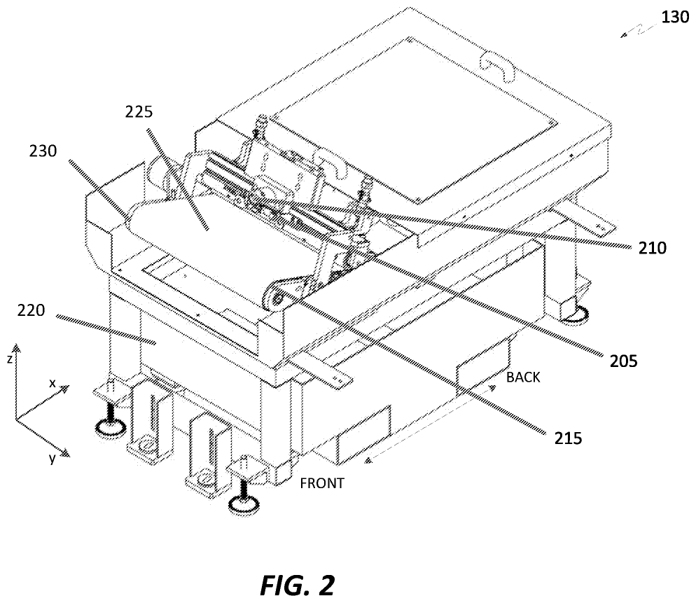

FIG. 2 is a perspective view of scrim-glass management station 130 in accordance with some embodiments of the present invention. Scrim-glass management station 130 can include a scriber wheel 205, a wheel rotate motor 210, a conveyor belt system 215, a collection bin 220. A scriber (not shown in detail) may be mounted on scriber wheel 205. Scriber wheel 205 can include a rotatable arm configured to rotate the scriber from a non-engaged position to an engaged position. In the engaged position, the scriber is rotated to physically contact the continuous scrim-glass web (not shown) being advanced through scrim-glass management station 130 by conveyor belt system 215. The scriber can include a diamond-tipped edge and/or other hard material(s). Examples of such a hard material include but are not limited to a steel carbide, a tungsten carbide, and a titanium carbide. The scriber is configured to physically weaken the structural integrity of the continuous scrim-glass web by causing a physical defect on at least the surface of the continuous scrim-glass web. In this way, scrim-glass management station 130 can more easily break a portion of the continuous scrim-glass web from the continuous scrim-glass web.

In some embodiments, scriber wheel 205 is coupled to wheel rotate motor 210. Wheel rotate motor 210 is configured to rotate scriber wheel 205 and the scriber from the engaged position to the non-engaged position and from the non-engaged position to the engaged position. Wheel rotate motor 210 can be an electric motor or a hydraulic cylinder, for example.

In some embodiments, rotate motor 210 is configured to rotate scriber wheel 205 such that a force in a range from 0.5 megapascals (MPa) to 2.0 MPa is applied onto the continuous scrim-glass web by the scriber. In one embodiment, rotate motor 210 is configured to rotate scriber wheel 205 such that a force less than or equal to 1.0 MPa is applied onto the continuous scrim-glass web by the scriber.

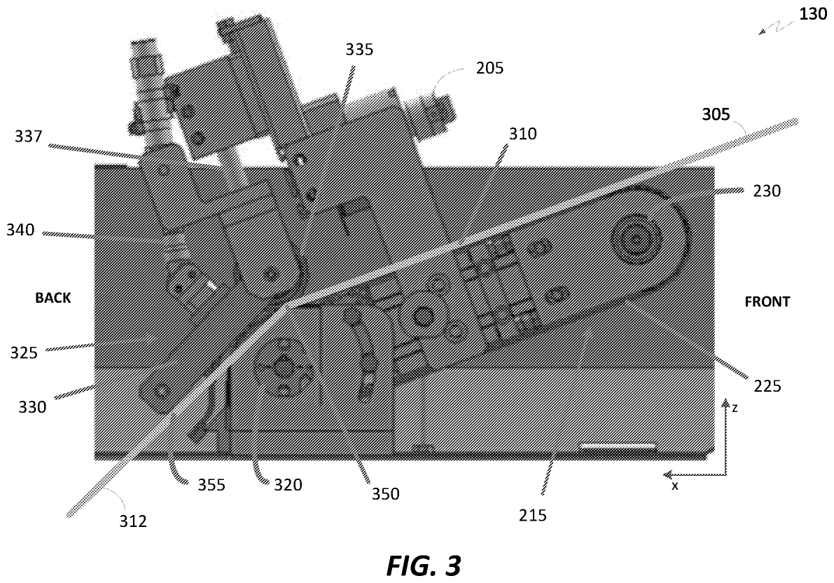

Conveyor belt system 215 includes a conveyor belt 225, a front conveyance roller 230 and a back conveyance roller (hidden from view, but described in FIG. 3 as 320). Front and back conveyance rollers are configured to rotate conveyor belt 225 such that the rotation of conveyor belt 225 moves the continuous scrim-glass web toward the back of scrim-glass management station 130 where the continuous scrim-glass web may be intermittently broken into portions. In one example implementation, front conveyance roller 230 and back conveyance roller (hidden) are mounted such that the front conveyance roller 230 is located higher relative to the back conveyance roller such that a line that intersects the centers of the respective front and back conveyance rollers forms an angle that is greater than zero with respect to a horizontal x-y plane within scrim-glass management station 130. In accordance with this implementation, mounting the front and back conveyance rollers in this way causes conveyor belt 225 to be tilted at the angle. In some embodiments, conveyor belt 225 can be tilted at an angle between 0 and 45 degrees with respect to the horizontal x-y plane.

In one example, conveyor belt 225 can be made of a urethane material or can have a surface coated with a urethane material. In another example, conveyor belt 225 can be made of a vibration-absorbing material. Examples of a vibration-absorbing material include but are not limited to rubber, synthetic rubber, and soft elastomeric urethane. By utilizing a vibration-absorbing material, vibrations that are caused by the continuous scrim-glass web being broken inside scrim-glass management station 130 can be at least partially absorbed by conveyor belt 225.

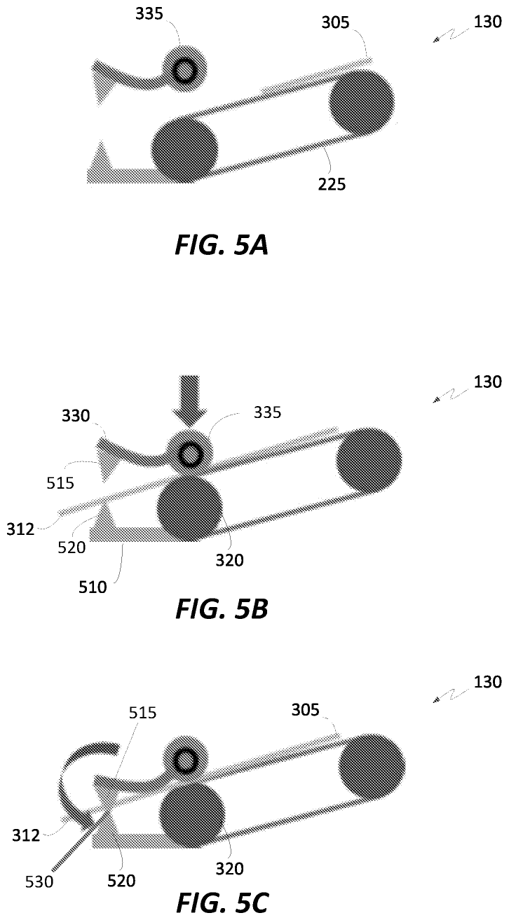

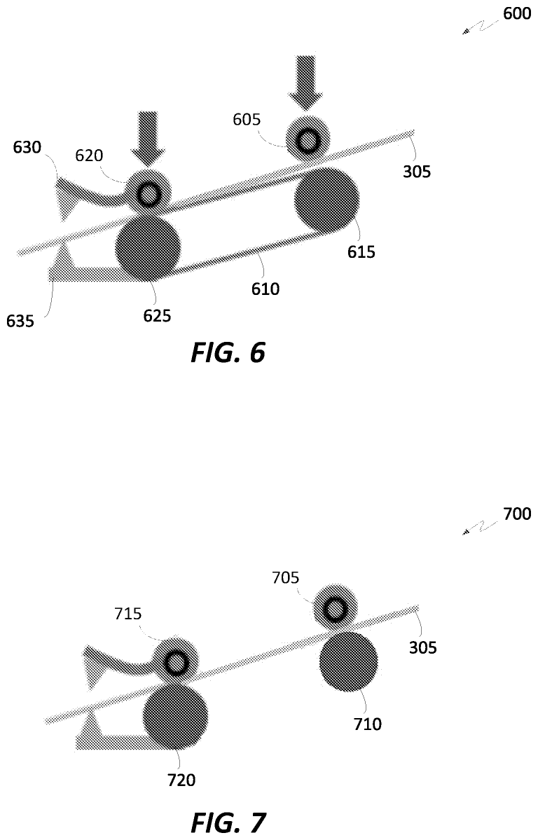

In some embodiments, scrim-glass management station 130 can further include a front nipping roller (not shown, but described in FIGS. 6 and 7 as 605 and 705, respectively) configured to press against conveyor belt 225 and to apply pressure to the continuous scrim-glass web, which is threaded between conveyor belt 225 and the front nipping roller (not shown). For example, the front nipping roller may be configured to press directly against front conveyance roller 230. In accordance with this example, conveyor belt 225 may be optional because the continuous scrim-glass web can be advanced toward the back of scrim-glass management station 130 by the front nipping roller (not shown) and front conveyance roller 230. The addition of the front nipping roller (not shown) can also help reduce vibration emanating from the continuous scrim-glass web during the web breaking process.

Collection bin 220 collects and stores broken portions (not shown) of the continuous scrim-glass web, which have been broken from the continuous scrim-glass web near the back of scrim-glass management station 130 using a breaker (not shown).

FIG. 3 is a side view of scrim-glass management station 130, shown in FIG. 1, in accordance with some embodiments of the present invention. As shown in FIG. 3, conveyor belt system 215 includes front conveyance roller 230 and back conveyance roller 320, which was previously hidden in FIG. 2. Front conveyance roller 230 and back conveyance roller 320 are configured to rotate conveyor belt 225 in a counter-clockwise direction (from the side perspective of FIG. 3) to push a continuous scrim-glass web 305 toward the back of scrim-glass management station 130 where continuous scrim-glass web 305 is broken into portions by a breaker arm.

In some embodiments, a back nipping roller 335 can be actuated to engage or disengage continuous scrim-glass web 305 using a hydraulic cylinder 337, which is configured to push back nipping roller 335 to an engaged position and to pull back nipping roller 335 to a disengaged position. In the engaged position, hydraulic cylinder 337 is extended to push back nipping roller 335 toward conveyor belt 225, which causes back nipping roller 335 to press against scrim-glass web 305 as scrim-glass web 304 passes between back nipping roller 335 and conveyor belt 225. The pressure applied to continuous scrim-glass web 305 by back nipping roller 335 and conveyor belt 225 effectively separates continuous scrim-glass web 305 into two separate vibrationally-isolated portions (or regions) 310 and 312 such that vibrations between the two portions are dampened by back nipping roller 335 and/or conveyor belt 225.

In one example, back nipping roller 335 can include a urethane material or can have a surface coated with a urethane material. In another example, back nipping roller 335 can include a vibration-absorbing material.

In some embodiments, each of the rollers can be configured to apply a force in a range from 0.25 MPa to 2.0 MPa onto continuous scrim-glass web 305. In one embodiment, each of back conveyance roller 320 and back nipping roller 335 can be configured to apply a force less than or equal to 1.0 MPa onto continuous scrim-glass web 305. The force may be applied with a specified (e.g., periodic) interval. For instance, the period interval may be 2 seconds, 2.5 seconds, 3 seconds, or 3.5 seconds.

As shown in FIG. 3, scrim-glass management station 130 includes breaker assembly 325, which includes breaker arm 330 and a breaker actuator 340. Breaker arm 330 can have a blunt or sharp edge (not shown) at the end portion of breaker arm 330. Breaker arm 330 may be configured to break portion 312 from continuous scrim-glass web 305 by using the blunt or sharp edge to apply a force to the surface of portion 312. In some embodiments, breaker arm 330 is configured to apply a torqueing force to portion 312 to break portion 312 from continuous scrim-glass web 305 at nipping point 350 by pushing down on portion 312 at location 355.

Breaker actuator 340 can be a hydraulic cylinder that is pivotably coupled to breaker arm 330, which is pivotably coupled to back nipping roller 335. When actuated, breaker actuator 340 extends and pushes breaker arm 330 downward toward portion 312 of continuous scrim-glass web 305. This results in a torqueing motion/force about nipping point 350, which causes portion 312 to snap away from continuous scrim-glass web 305.

In some embodiments, actuation of breaker arm 330 is controlled by controller 150, which is described above with reference to FIG. 1. For example, controller 150 can control the actuation of breaker arm 330 by causing breaker arm 330 to intermittently apply a torqueing motion to portion 312 of continuous scrim-glass web 305 as continuous scrim-glass web 305 moves toward the back of scrim-glass management station 130. In accordance with this example, controller 150 may cause breaker arm 330 to apply the torqueing motion each time a physical defect on the surface of continuous scrim-glass web 305 that is caused by a scriber (not shown) of scriber wheel 205 passes nipping point 350. In this way, portions (e.g., portion 312) of continuous scrim-glass web 305 can more easily break away from continuous scrim-glass web 305.

In an aspect of the example mentioned above, controller 150 may cause breaker arm 330 to intermittently apply a force having a magnitude that is sufficient to break the portions from continuous scrim-glass web 305. In one example implementation, controller 150 may cause breaker arm 330 to apply a sudden force to break portion 312 from continuous scrim-glass web 305. In another example implementation, controller 150 may cause breaker arm 330 to apply a gradually increasing force to break portion 312 from continuous scrim-glass web 305. For instance, by applying the gradually increasing force, the amount of vibration that is introduced to continuous scrim-glass web 305 can be reduced.

In some embodiments, controller 150 may cause breaker arm 330 to intermittently apply a force to each portion of continuous scrim-glass web 305 based on a determination that a physical defect on the surface of continuous scrim-glass web 305 that corresponds to the portion is at (or near) location 355. In this way, portion 312 can be easily broken from continuous scrim-glass web 305. Controller 150 can intermittently actuate breaker arm 330, using breaker actuator 340, based at least in part on the web speed, which is the speed at which continuous scrim-glass web 305 traverses over first and/or second conveyance rollers (e.g., over conveyor belt 225, which rotates about the first and second conveyance rollers). A higher web speed can correspond to using a higher actuation rate of breaker arm 330. Similarly, a slower web speed can correspond to using a slower actuation rate of breaker arm 330. Additionally, controller 150 can adjust the rate of actuation of breaker arm 330 based at least in part on the rate at which the scriber that is mounted on scriber wheel 205 scribes the surface of continuous scrim-glass web 305.

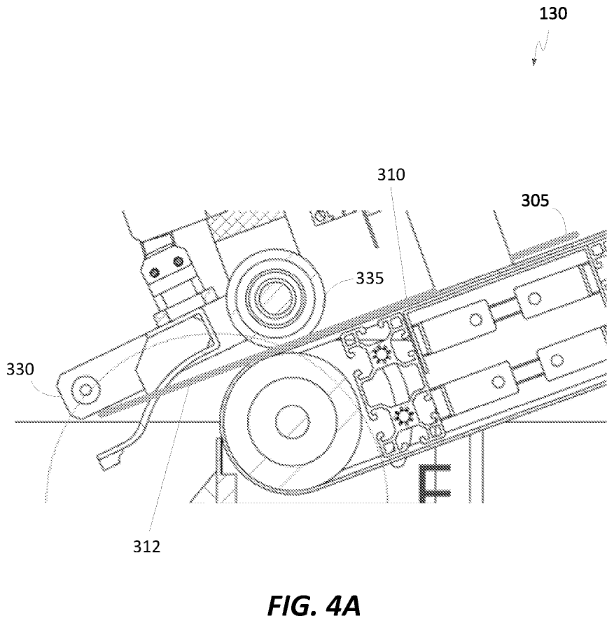

FIGS. 4A and 4B are side views of scrim-glass management station 130, shown in FIG. 1, in respective non-actuated and actuated states in accordance with some embodiments of the present disclosure. As shown in FIG. 4A, the non-actuated state of scrim-glass management station 130 is defined by breaker arm 330 being in the disengaged (up) position where it is not in contact with portion 312 of continuous scrim-glass web 305. As shown in FIG. 4B, the actuated state of scrim-glass management station 130 is defined by breaker arm 330 being in the engaged (down) position where it is in contact with portion 312 of continuous scrim-glass web 305. It should be noted that breaker actuator 340 (shown in FIG. 3) can control breaker arm 330 based on a control signal that is received from controller 150 (shown in FIG. 1). For example, breaker actuator 340 can control breaker arm 330 to be in the disengaged position based on the control signal having a first value. In another example, breaker actuator 340 can control breaker arm 330 to be in the engaged position based on the control signal having a second value that is different from the first value. For instance, breaker actuator 340 can actuate breaker arm 330 to break a portion (e.g., portion 312) from continuous scrim-glass web 305 based on the control signal having the second value.

In some embodiments, back nipping roller 335 is constantly in an engaged (down) position. Accordingly, nipping roller 335 can remain in contact with continuous glass web 305. In one example implementation, while back nipping roller 335 is in the engaged position, a motor rotates back nipping roller 335 in a clockwise direction to push continuous scrim-glass web 305 downstream (i.e., toward the back of scrim-glass management station 130). In another example implementation, back nipping roller 335 is not motorized and can freely rotate in the clockwise or counter-clockwise direction. In some embodiments, controller 150 can disengage back nipping roller 335 to enable continuous scrim-glass web 305 to be threaded through scrim-glass management station 130. Once continuous scrim-glass web 305 is threaded, back nipping roller 335 can remain engaged while portion 312 is being cut (e.g., removed) from continuous scrim-glass web 305 by breaker arm 330.

As shown in FIG. 4B, breaker arm 330 presses down on portion 312 of continuous scrim-glass web 305, and the downward or torqueing motion created by breaker arm 330 causes portion 312 to break away from continuous scrim-glass web 305 at approximately location 405, which is just beyond nipping point 350. In an example implementation, breaker arm 330 is configured to operate like a hammer and come down forcefully on portion 312 of continuous scrim-glass web 305. In accordance with this implementation, portion 312 can be shattered at approximately contact point 415. Back nipping roller 335 and/or conveyor belt 225 (shown in FIGS. 2-3) can act as a vibrational damper and can absorb a substantial amount of the vibrations generated by the breaking of portion 312 from continuous scrim-glass web 305. Once portion 312 of continuous scrim-glass web 305 is broken off, portion 312 can be collected and stored in a collector bin (not shown).

In some embodiments, the use of conveyor belt 225 is optional. For example, continuous scrim-glass web 305 can instead be threaded directly between front nipping roller (not shown) and front conveyance roller 230 (shown in FIGS. 2 and 3). In accordance with this example, front conveyance roller 230 can be configured to support and move continuous scrim-glass web 305 toward the back of scrim-glass management station 130 at relatively the same speed as glass web 115. In another example, continuous scrim-glass web 305 can also be threaded directly between back nipping roller 335 and back conveyance roller 320 (shown in FIG. 3). In accordance with this example, back conveyance roller 320 can be configured to support and move continuous scrim-glass web 305 at relative the same speed as glass web 115.

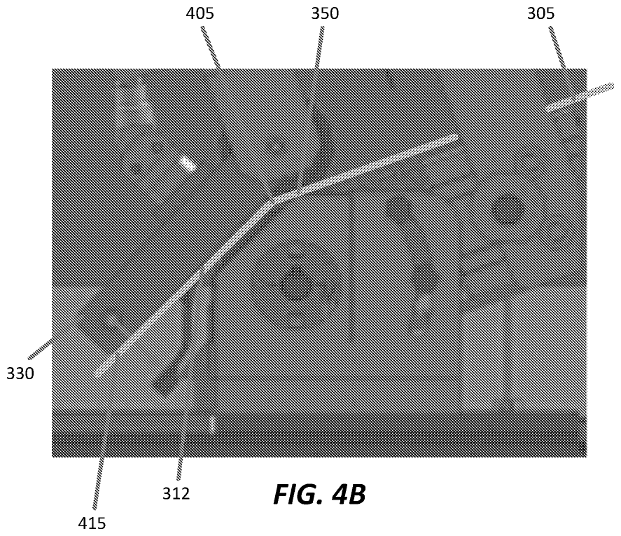

FIGS. 5A, 5B, and 5C are side views of scrim-glass management station 130, shown in FIG. 1, at various stages of the scrim-glass web breaking process in accordance with some embodiments of the present invention. In FIG. 5A, back nipping roller 335 is in a non-engaged (up) position where it is not touching conveyor belt 225. In some embodiments, back nipping roller 335 can be in a non-engaged position in a set-up stage in which continuous scrim-glass web 305 is being initially received by scrim management station 130. For example, conveyor belt 225 receives continuous scrim-glass web 305, which has been slit from glass web 115 (shown in FIG. 1). Conveyor belt 225 can be configured to rotate at a rate that causes continuous scrim-glass web 305 to be moved at the same rate of speed as the glass web 115. Conveyor belt 225 can rotate in a counter-clockwise direction to push continuous scrim-glass web 305 toward the back of scrim management station 130.

In FIG. 5B, back nipping roller 335 is advanced toward conveyor belt 225 to apply pressure onto continuous scrim-glass web 305. In some embodiments, controller 150 (shown in FIG. 1) is configured to actuate hydraulic cylinder 337 (shown in FIG. 3) to cause back nipping roller 335 to engage or disengage continuous scrim-glass web 305. In some embodiments, controller 150 is configured to cause back nipping roller 335 to apply a pressure to continuous scrim-glass web 305 that is large enough to sufficiently dampen vibrations emanating from continuous scrim-glass web 305 but not large enough to hinder the rotation of back nipping roller 335 or the translation of continuous scrim-glass web 305 through scrim-glass management station 130.

In some embodiments, scrim-glass management station 130 includes two breaker arms, breaker arm 330 and breaker arm 510. Breaker arm 330 includes a breaking hammer 515, and breaker arm 510 includes a breaking hammer 520. Breaker arm 330 can be pivotably mounted to back nipping roller 335. In an example implementation, breaker arm 510 is pivotably mounted to a structure in scrim-glass management station 130. For instance, breaker arm 510 can be pivotably mounted to back conveyance roller 320. In another example implementation, breaker arm 510 is fixedly mounted to a structure in scrim-glass management station 130. Breaker arm 330 and breaker arm 510 can be actuated using motors (e.g., hydraulic cylinders), which are not shown in FIG. 5B.

In some embodiments, each of breaking hammers 515 and 520 is configured to apply a sudden crushing force to a relatively small area 530 of a respective side of portion 312 of continuous scrim-glass web 305, as depicted in FIG. 5C. For instance, the crushing force may be a force that is sufficient to crush portion 312. Because the sudden crushing force is concentrated to a relatively small area 530, portion 312 may shatter upon receiving the sudden crushing force from breaking hammers 515 and 520. In some embodiments, the crushing force applied by breaking hammers 515 and 520 can be adjusted by varying the torque of the motor or the pressure of the hydraulic cylinder that is coupled to each of the breaking hammers 515 and 520. In such embodiments, the scribing process (using a scriber of scriber wheel 205 shown in FIG. 3) that is used to create a physical defect on the surface of continuous scrim-glass web 305 may not be necessary because the crushing force can be adjusted to any suitable force that is required to break portion 312 from continuous scrim-glass web 305. In some embodiments, the scriber of scriber wheel 205 can be used in conjunction with breaking hammers 515 and 520 to enable a reduction of the magnitude of the crushing force that is required to break portion 312 from continuous scrim-glass web 305. In this way, vibrations created by the crushing process can be reduced.

FIG. 6 is a side view of a scrim-glass management station 600 in accordance with some embodiments of the present disclosure. Scrim-glass management station 600 can include one or more features or functions of scrim-glass management station 130 as described above with reference to FIGS. 2-3, 4A-4B, and 5A-5C. As shown in FIG. 6, scrim-glass management station 600 includes a front nipping roller 605 configured to engage and apply pressure to a belt 610 and/or a front conveyance roller 615. Front nipping roller 605 can have a surface made of one or more vibration-absorbing materials, though the scope of the example embodiments is not limited in this respect. Front nipping roller 605 can be coupled to a motor or a hydraulic actuator (not shown) that is configured to lower front nipping roller 605 toward front conveyance roller 615 and/or belt 610 to create pressure between nipping roller 605 and belt 610. Thus, when continuous scrim-glass web 305 is threaded between front nipping roller 605 and belt 610, pressure is being applied to opposite sides of continuous scrim-glass web 305. This helps to vibrationally isolate the portion of continuous scrim-glass web 305 that is between first nipping roller 605 and breaker arms 630 and 635 from the portion of continuous scrim-glass web 305 that has not yet reached first nipping roller 605.

Similar to scrim-glass management station 130, scrim-glass management station 600 also includes a back nipping roller 620 and a back conveyance roller 625, which are configured to further vibrationally isolate the portion of continuous scrim-glass web 305 that has passed back nipping roller 620. Belt 610 can also help absorb any vibration from continuous scrim-glass web 305.

FIG. 7 is a side view of a scrim-glass management station 700 in accordance with some embodiments of the present disclosure. Scrim-glass management station 700 can include one or more features or functions of scrim-glass management stations 130 and 600 as described above with reference to FIGS. 2-3, 4A-4B, 5A-5C, and 6. As shown in FIG. 7, scrim-glass management station 700 does not include a conveyor belt. Rather, scrim-glass management station 700 includes a pair of nipping rollers (i.e., a front nipping roller 705 and a back nipping roller 715) and a pair of conveyance rollers (i.e., a front conveyance roller 710 and a back conveyance roller 720) as the primary means for supporting, moving, and vibrationally isolating continuous scrim-glass web 305. In operation, continuous scrim-glass web 305 can be threaded between front nipping roller 705 and front conveyance roller 710 and between back nipping roller 715 and back conveyance roller 720, as depicted in FIG. 7. The pressure being applied to continuous scrim-glass web 305 by the rollers 705, 710, 715, and 720 is sufficient to hold, support, and move continuous scrim-glass web 305.

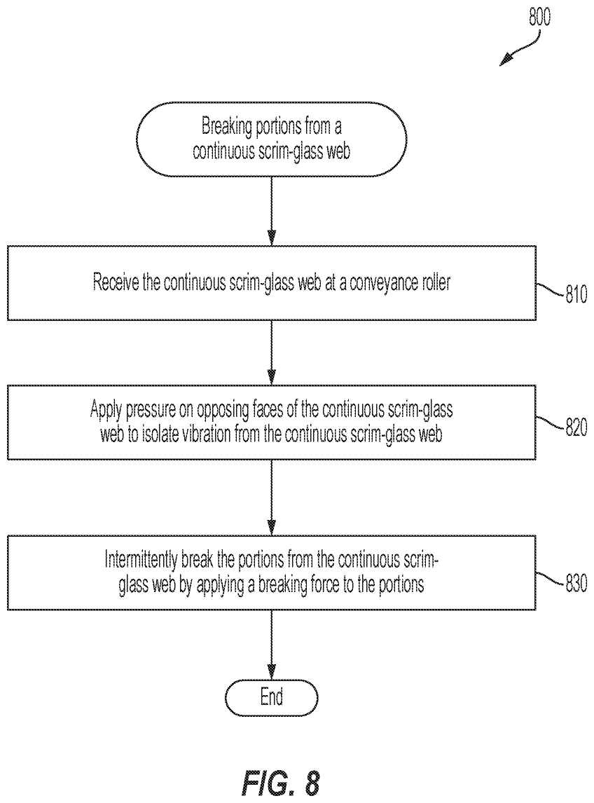

FIG. 8 depicts a flowchart 800 of an example method for breaking (e.g., intermittently breaking) portions from a continuous scrim-glass web in accordance with some embodiments of the present disclosure. In the embodiment of FIG. 8, the continuous scrim-glass web is slit from a side of a continuous glass web (e.g., glass web 115). Flowchart 800 may be performed by scrim-glass management station 130, embodiments of which are shown in respective FIGS. 2-3, 4A-4B, 5A-5C, and 6-7, for example. For illustrative purposes, flowchart 800 will be described with reference to scrim-glass management station 130. Further structural and operational embodiments will be apparent to persons skilled in the relevant art(s) based on the discussion regarding the flowchart 800.

As shown in FIG. 8, the method of flowchart 800 starts at 810 where a continuous scrim-glass web is received at a conveyance roller. In one example, receiving the continuous scrim-glass web at step 810 may include receiving the continuous scrim-glass web onto a conveyor belt that rotates about the conveyance roller. In another example, receiving the continuous scrim-glass web at step 810 may include receiving the continuous scrim-glass web at the conveyance roller and at another conveyance roller that rotate about respective first and second axes that are positioned in a common plane. In accordance with this example, an angle between the common plane and a horizontal plane may be at least a threshold angle. For instance, the threshold angle may be 10 degrees, 15 degrees, 20 degrees, or 25 degrees. Any of the conveyance roller(s) and/or the conveyor belt may have a surface that includes a vibration-absorbing material, such as urethane.

In an example implementation, conveyance roller 230 receives continuous scrim-glass web 305 from slitting station 120. In accordance with this implementation, conveyance roller 230 may push continuous scrim-glass web 305 toward the back of scrim-glass management station 130 where continuous scrim-glass web 305 will be broken (e.g., crushed). In another example implementation, a conveyance roller of slitting station 120 guides continuous scrim-glass web 305 onto conveyor belt 610, which is supported and rotated by front and back conveyance rollers 615 and 625, respectively.

At 820, pressure is applied to opposing faces of the continuous scrim-glass web to isolate vibration from the continuous scrim-glass web (e.g., by pressing the continuous scrim-glass web between a nipping roller and the conveyance roller). For example, front nipping roller 605 and conveyance roller 615 (e.g., conveyor belt 610) can apply pressure to continuous scrim-glass web 305 by squeezing continuous scrim-glass web 305 therebetween. In another example, front nipping roller 705 and conveyance roller 710 can apply pressure to continuous scrim-glass web 305 by squeezing continuous scrim-glass web 305 therebetween. Back nipping roller 620 and conveyance roller 625 (e.g., conveyor belt 610) can apply additional pressure on continuous scrim-glass web 305. In this way, continuous scrim-glass web 305 may be vibrationally isolated at two different locations. This can substantially decrease the amount of vibration being propagated upstream (to glass web 115).

In an example embodiment, applying the pressure at step 820 includes reducing vibration that originates from the continuous scrim-glass web and that is caused by the breaker intermittently breaking the portions from the continuous scrim-glass web by at least a threshold percentage. For instance, the threshold percentage may be 80%, 85%, 90%, or 95%. For example, nipping rollers 705 and 715 can reduce vibration emanating from continuous scrim-glass web 305 by at least the threshold percentage by applying an appropriate amount of pressure onto continuous scrim-glass web 305.

At 830, portions of the continuous scrim-glass web are intermittently broken from the continuous scrim-glass web by applying a breaking force to the portions. For instance, a breaker may intermittently break the portions from the continuous scrim-glass web as the continuous scrim-glass web passes between the nipping roller and the conveyance roller. The breaking force can be a gradually increasing force or a sudden high-powered force. For example, breaker arm 330 in FIG. 3 or one or more of breaking hammers 515 and 520 in FIGS. 5B-5C may intermittently break the portions from continuous scrim-glass web 305 by applying the breaking force to the portions.

In an example embodiment, the breaking force includes a first force and a second force. In accordance with this embodiment, intermittently breaking the portions from the continuous scrim-glass web at step 830 includes intermittently inducing a stress in the continuous scrim-glass web that causes the portions to be broken from the continuous scrim-glass web by applying the respective first and second forces on opposing first and second faces of the continuous scrim-glass web. For example, hammers 630 and 635 can induce the stress in continuous scrim-glass web 305 by applying the respective first and second forces on opposing surfaces of continuous scrim-glass web 305. The stress can be induced by applying a gradually increasing force or a strong and sudden force that is sufficient to break the portions from continuous scrim-glass web 305. A strong and sudden force can be a forced that is applied in a relatively short amount of time (e.g., less than 0.2 seconds).

In some example embodiments, one or more steps 810, 820, and/or 830 of flowchart 800 may not be performed. Moreover, steps in addition to or in lieu of steps 810, 820, and/or 830 may be performed. For instance, in an example embodiment, the method of flowchart 800 further includes intermittently scoring sections of the continuous scrim-glass web to cause physical defects using a scriber. For example, a scriber of scriber wheel 205 can score sections of continuous scrim-glass web 305 to create physical defects on the surface of continuous scrim-glass web 305. The scriber can be mounted to a rotatable arm of scriber wheel 205, though the scope of the example embodiments is not limited in this respect. In accordance with this embodiment, intermittently breaking the portions from the continuous scrim-glass web at step 830 includes intermittently breaking the portions from the continuous scrim-glass web at the physical defects by applying the breaking force to the portions. In one aspect of this embodiment, intermittently scoring the sections of the continuous scrim-glass web includes intermittently swinging the scriber, which is mounted to a rotatable arm, by rotating the rotatable arm about an axis to score the sections of the continuous scrim-glass web. In another aspect of this embodiment, intermittently scoring the sections of the continuous scrim-glass web includes intermittently translating the scriber in a cross-web direction of the continuous scrim-glass web using a linear motor that is mounted to the scriber to score the continuous scrim-glass web.

In another example embodiment, the method of flowchart 800 further includes collecting the portions, which are broken from the continuous scrim-glass web (e.g., by the breaker) in a collection bin. For instance, collection bin 220 in FIG. 2 may collect the portions.

### II. FURTHER DISCUSSION OF SOME EXAMPLE EMBODIMENTS

A first example system includes a first roller, a nipping roller, and a breaker. The first roller is configured to support the continuous scrim-glass web. The nipping roller is configured to isolate vibration originating from the continuous scrim-glass web by applying pressure onto the continuous scrim-glass web that is threaded between the nipping roller and the first roller. The breaker is configured to intermittently break portions of the continuous scrim-glass web from the continuous scrim-glass web while the continuous scrim-glass web traverses between the nipping roller and the first roller by applying a force to the continuous scrim-glass web.

In a first aspect of the first example system, the system further comprises a second roller and a conveyor belt that is partially wrapped around each of the first and second rollers. In accordance with the first aspect, at least one of the first roller or the second roller is configured to rotate the conveyor belt.

In a first implementation of the first aspect of the first example system, the first roller is configured to rotate the conveyor belt.

In a second implementation of the first aspect of the first example system, the conveyor belt has a surface that comprises at least one of urethane or rubber.

In a second aspect of the first example system, the first and second rollers are configured to rotate about respective first and second axes that are included in a common plane. In accordance with the second aspect, an angle between the common plane and a horizontal plane is at least 20 degrees. The second aspect of the first example system may be implemented in combination with the first aspect of the first example system, though the example embodiments are not limited in this respect.

In a third aspect of the first example system, the first example system further comprises a scriber configured to cause a defect on a surface of the continuous scrim-glass web by creating a scribe mark on the surface. In accordance with the third aspect, the breaker is configured to break a portion of the continuous scrim-glass web from the continuous scrim-glass web by applying the force to the portion. The third aspect of the first example system may be implemented in combination with the first and/or second aspect of the first example system, though the example embodiments are not limited in this respect.

In a first implementation of the third aspect of the first example system, the first example system further comprises a rotatable arm configured to rate about an axis. In accordance with the first implementation, the scriber is mounted on an end of the rotatable arm. In further accordance with the first implementation, the rotatable arm is configured to intermittently swing the scriber in an angular direction about the axis to create scribe marks on the surface of the continuous scrim-glass web.

In a second implementation of the third aspect of the first example system, the first example system further comprises a linear motor configured to intermittently translate the scriber in a cross-web direction of the continuous scrim-glass web.

In a fourth aspect of the first example system, the nipping roller is configured to reduce the vibration originating from the continuous scrim-glass web, which is caused by the breaker intermittently breaking the portions from the continuous scrim-glass web, by at least 90 percent. The fourth aspect of the first example system may be implemented in combination with the first, second, and/or third aspect of the first example system, though the example embodiments are not limited in this respect.

In a fifth aspect of the first example system, the first example system further comprises a collecting bin configured to collect the portions that are broken from the continuous scrim-glass web by the breaker. The fifth aspect of the first example system may be implemented in combination with the first, second, third, and/or fourth aspect of the first example system, though the example embodiments are not limited in this respect.

In a sixth aspect of the first example system, the breaker comprises a glass breaking instrument mounted on a rotatable arm that is configured to rotate the glass breaking instrument to break the portions from the continuous scrim-glass web. The sixth aspect of the first example system may be implemented in combination with the first, second, third, fourth, and/or fifth aspect of the first example system, though the example embodiments are not limited in this respect.

In a seventh aspect of the first example system, the force includes a first force and a second force. In accordance with the seventh aspect, the breaker includes first and second members configured to collaboratively intermittently induce a stress in the continuous scrim-glass web that causes the portions to be broken from the continuous scrim-glass web by applying the respective first and second forces on opposing first and second faces of the continuous scrim-glass web. The seventh aspect of the first example system may be implemented in combination with the first, second, third, fourth, fifth, and/or sixth aspect of the first example system, though the example embodiments are not limited in this respect.

A second example system includes a slitting station, a first scrim management station, and a second scrim management station. The slitting station is configured to slit a continuous glass web into first, second, and third continuous webs. The first and second continuous webs are continuous scrim-glass webs slit from respective left and right sides of the continuous glass web. The first scrim management station comprises a first nipping roller and a first breaker. The first nipping roller is configured to isolate vibration originating from the first continuous scrim-glass web by applying pressure onto the first continuous scrim-glass web that is between the first nipping roller and a first support roller. The first breaker is configured to intermittently break portions of the first continuous scrim-glass web from the first continuous scrim-glass web while the first continuous scrim-glass web traverses between the first nipping roller and the first support roller by applying a force to the first continuous scrim-glass web. The second scrim management station comprises a second nipping roller and a second breaker. The second nipping roller is configured to isolate vibration originating from the second continuous scrim-glass web by applying pressure onto the second continuous scrim-glass web that is between the second nipping roller and a second support roller. The second breaker is configured to intermittently break portions of the second continuous scrim-glass web from the second continuous scrim-glass web while the second continuous scrim-glass web traverses between the second nipping roller and the second support roller by applying a force to the second continuous scrim-glass web.

In an example method of intermittently breaking portions of a continuous scrim-glass web from the continuous scrim-glass web, which is slit from a side of a continuous glass web, the continuous scrim-glass web is received at a first conveyance roller. Pressure is applied on opposing faces of the continuous scrim-glass web to isolate vibration from the continuous scrim-glass web by pressing the continuous scrim-glass web between a nipping roller and the first conveyance roller. Portions are intermittently broken from the continuous scrim-glass web as the continuous scrim-glass web passes between the nipping roller and the first conveyance roller by applying a breaking force, using a breaker, to the portions.

In a first aspect of the example method, receiving the continuous scrim-glass web at the first conveyance roller comprises receiving the continuous scrim-glass web onto a conveyor belt that rotates about the first conveyance roller.

In an implementation of the first aspect of the example method, receiving the continuous scrim-glass web onto the conveyor belt comprises receiving the continuous scrim-glass web onto the conveyor belt that has a surface that includes at least one of urethane or rubber.

In a second aspect of the example method, receiving the continuous scrim-glass web comprises receiving the continuous scrim-glass web at the first conveyance roller and at a second conveyance roller that rotate about respective first and second axes that are positioned in a common plane. In accordance with the second aspect, an angle between the common plane and a horizontal plane is at least 20 degrees. The second aspect of the example method may be implemented in combination with the first aspect of the example method, though the example embodiments are not limited in this respect.

In a third aspect of the example method, the example method further comprises intermittently scoring sections of the continuous scrim-glass web to cause physical defects using a scriber. In accordance with the third aspect, intermittently breaking the portions from the continuous scrim-glass web comprises intermittently breaking the portions from the continuous scrim-glass web at the physical defects by applying the breaking force to the portions. The third aspect of the example method may be implemented in combination with the first and/or second aspect of the example method, though the example embodiments are not limited in this respect.

In a first implementation of the third aspect of the example method, intermittently scoring the sections of the continuous scrim-glass web comprises intermittently swinging the scriber, which is mounted to a rotatable arm, by rotating the rotatable arm about an axis to score the sections of the continuous scrim-glass web.

In a second implementation of the third aspect of the example method, intermittently scoring the sections of the continuous scrim-glass web comprises intermittently translating the scriber in a cross-web direction of the continuous scrim-glass web using a linear motor that is mounted to the scriber to score the continuous scrim-glass web.

In a fourth aspect of the example method, applying the pressure on the opposing faces of the continuous scrim-glass web comprises reducing vibration that originates from the continuous scrim-glass web and that is caused by the breaker intermittently breaking the portions from the continuous scrim-glass web by at least 90 percent. The fourth aspect of the example method may be implemented in combination with the first, second, and/or third aspect of the example method, though the example embodiments are not limited in this respect.

In a fifth aspect of the example method, the example method further comprises collecting the portions, which are broken from the continuous scrim-glass web by the breaker, in a collection bin. The fifth aspect of the example method may be implemented in combination with the first, second, third, and/or fourth aspect of the example method, though the example embodiments are not limited in this respect.

In a sixth aspect of the example method, the breaking force includes a first force and a second force. In accordance with the sixth aspect, intermittently breaking the portions from the continuous scrim-glass web comprises intermittently inducing a stress in the continuous scrim-glass web that causes the portions to be broken from the continuous scrim-glass web by applying the respective first and second forces on opposing first and second faces of the continuous scrim-glass web.

### III. CONCLUSION

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

Where a discrete value or range of values is set forth, it is noted that that value or range of values may be claimed more broadly than as a discrete number or range of numbers, unless indicated otherwise. For example, each value or range of values provided herein may be claimed as an approximation and this paragraph serves as antecedent basis and written support for the introduction of claims, at any time, that recite each such value or range of values as “approximately” that value, “approximately” that range of values, “about” that value, and/or “about” that range of values. Conversely, if a value or range of values is stated as an approximation or generalization, e.g., approximately X or about X, then that value or range of values can be claimed discretely without using such a broadening term. Those of skill in the art will readily understand the scope of those terms of approximation.

1. A system to manage a continuous scrim-glass web slit from a side of a continuous glass web, the system comprising:
a first roller configured to support the continuous scrim-glass web;
a nipping roller configured to isolate vibration originating from the continuous scrim-glass web by applying pressure onto the continuous scrim-glass web that is threaded between the nipping roller and the first roller; and
a breaker configured to intermittently break portions of the continuous scrim-glass web from the continuous scrim-glass web while the continuous scrim-glass web traverses between the nipping roller and the first roller by applying a force to the continuous scrim-glass web.

2. The system of claim 1, further comprising:
a second roller; and
a conveyor belt that is partially wrapped around each of the first and second rollers, wherein at least one of the first roller or the second roller is configured to rotate the conveyor belt.

3. The system of claim 1, wherein the first roller is configured to rotate the conveyor belt.

4. The system of claim 2, wherein the conveyor belt has a surface that comprises at least one of urethane or rubber.

5. The system of claim 2, wherein the first and second rollers are configured to rotate about respective first and second axes that are included in a common plane; and
wherein an angle between the common plane and a horizontal plane is at least 20 degrees.

6. The system of claim 1, further comprising:
a scriber configured to cause a defect on a surface of the continuous scrim-glass web by creating a scribe mark on the surface;
wherein the breaker is configured to break a portion of the continuous scrim-glass web from the continuous scrim-glass web by applying the force to the portion.

7. The system of claim 6, further comprising:
a rotatable arm configured to rotate about an axis;
wherein the scriber is mounted on an end of the rotatable arm; and
wherein the rotatable arm is configured to intermittently swing the scriber in an angular direction about the axis to create scribe marks on the surface of the continuous scrim-glass web.

8. The system of claim 6, further comprising:
a linear motor configured to intermittently translate the scriber in a cross-web direction of the continuous scrim-glass web.

9. The system of claim 1, wherein the nipping roller is configured to reduce the vibration originating from the continuous scrim-glass web, which is caused by the breaker intermittently breaking the portions from the continuous scrim-glass web, by at least 90 percent.

10. The system of claim 1, wherein the breaker comprises a glass breaking instrument mounted on a rotatable arm that is configured to rotate the glass breaking instrument to break the portions from the continuous scrim-glass web.

11. The system of claim 1, wherein the force includes a first force and a second force; and
wherein the breaker includes first and second members configured to collaboratively intermittently induce a stress in the continuous scrim-glass web that causes the portions to be broken from the continuous scrim-glass web by applying the respective first and second forces on opposing first and second faces of the continuous scrim-glass web.

12. A method of intermittently breaking portions of a continuous scrim-glass web from the continuous scrim-glass web, the continuous scrim-glass web slit from a side of a continuous glass web, the method comprising:
receiving the continuous scrim-glass web at a first conveyance roller;
applying pressure on opposing faces of the continuous scrim-glass web to isolate vibration from the continuous scrim-glass web by pressing the continuous scrim-glass web between a nipping roller and the first conveyance roller; and
intermittently breaking the portions from the continuous scrim-glass web as the continuous scrim-glass web passes between the nipping roller and the first conveyance roller by applying a breaking force, using a breaker, to the portions.

13. The method of claim 12, wherein receiving the continuous scrim-glass web at the first conveyance roller comprises:
receiving the continuous scrim-glass web onto a conveyor belt that rotates about the first conveyance roller.

14. The method of claim 12, wherein receiving the continuous scrim-glass web onto the conveyor belt comprises:
receiving the continuous scrim-glass web onto the conveyor belt that has a surface that includes at least one of urethane or rubber.

15. The method of claim 12, wherein receiving the continuous scrim-glass web comprises:
receiving the continuous scrim-glass web at the first conveyance roller and at a second conveyance roller that rotate about respective first and second axes that are positioned in a common plane; and
wherein an angle between the common plane and a horizontal plane is at least 20 degrees.

16. The method of claim 12, further comprising:
intermittently scoring sections of the continuous scrim-glass web to cause physical defects using a scriber; and
wherein intermittently breaking the portions from the continuous scrim-glass web comprises:
intermittently breaking the portions from the continuous scrim-glass web at the physical defects by applying the breaking force to the portions.

17. The method of claim 16, wherein intermittently scoring the sections of the continuous scrim-glass web comprises:
intermittently swinging the scriber, which is mounted to a rotatable arm, by rotating the rotatable arm about an axis to score the sections of the continuous scrim-glass web.

18. The method of claim 16, wherein intermittently scoring the sections of the continuous scrim-glass web comprises:
intermittently translating the scriber in a cross-web direction of the continuous scrim-glass web using a linear motor that is mounted to the scriber to score the continuous scrim-glass web.

19. The method of claim 12, wherein applying the pressure on the opposing faces of the continuous scrim-glass web comprises:
reducing vibration that originates from the continuous scrim-glass web and that is caused by the breaker intermittently breaking the portions from the continuous scrim-glass web by at least 90 percent.

20. The method of claim 12, wherein the breaking force includes a first force and a second force; and
wherein intermittently breaking the portions from the continuous scrim-glass web comprises:
intermittently inducing a stress in the continuous scrim-glass web that causes the portions to be broken from the continuous scrim-glass web by applying the respective first and second forces on opposing first and second faces of the continuous scrim-glass web.

21. (canceled)
